(19) United States
(12) Patent Application Publication
(10) Pub. No.: US 2019/0347358 A1
(43) Pub. Date: Nov. 14, 2019

(54) Query Formulation Using Networked Device Candidates

(71) Applicant: MICROSOFT TECHNOLOGY LICENSING, LLC, Redmond, WA (US)

(72) Inventors: Abhineet Mishra, Bothell, WA (US); Venkata Madhu Sravanth Kurumaddali, Redmond, WA (US)

(21) Appl. No.: 15/975,919

(22) Filed: May 10, 2018

(51) Int. Cl. G06F 17/30; G06F 17/27; G06F 3/16

(52) U.S. Cl. CPC G06F 17/30864; G06F 3/167; G06F 17/278; G06F 17/30637

(57) ABSTRACT

Techniques for generating enhanced query formulations by leveraging data from network-coupled devices, e.g., sensors coupled to the Internet of Things (IoT). In an aspect, one or more query-related sensor candidates are retrieved from a sensor entity data store. The most relevant sensor candidates are determined, and the sensor's identities and data are leveraged to alter and enhance the quality and accuracy of query formulations submitted to an online search engine. The techniques may be applied to improve the query understanding capabilities of search engines, as well as natural language processing capabilities of personal digital assistants.

### BACKGROUND

Query understanding for digital information retrieval systems is generally a complex task in the technical field of artificial language processing, requiring knowledge and application of extensive syntactic and semantic rules. In particular, a user often has little or no understanding of the underlying structure behind the information retrieval system, so user-formulated queries generally may not identify and retrieve the most relevant information.

To improve query understanding, recent advances in sensor networks and ubiquitous wireless connectivity may be leveraged. In particular, there is made increasingly available a large, continuously generated amount of networked data which can provide significant semantic context to user queries, and thus aid information retrieval systems in responding to queries more accurately and efficiently.

It would be desirable to provide improved and personalized query formulation techniques by utilizing a user's networked sensor data, thereby enhancing the relevance and accuracy of user-generated queries for search engine, personal digital assistant, and other information retrieval applications.

### BRIEF DESCRIPTION OF THE DRAWINGS

FIG. 1 shows an illustrative application of techniques of the present disclosure.

FIG. 2 shows an alternative illustrative application of techniques of the present disclosure.

FIG. 3 illustrates an exemplary embodiment of a system for generating sensor-enhanced search results responsive to user queries.

FIG. 4 illustrates operations executed by an exemplary embodiment of module 322 in FIG. 3.

FIG. 5 illustrates exemplary instances of look-up sequences, retrieved candidates, and associated relevance scores.

FIG. 6 illustrates an exemplary embodiment of an apparatus according to the present disclosure.

FIG. 7 illustrates an exemplary embodiment of an IoT data collection system in which techniques of the present disclosure may be applied.

FIG. 8 shows an IoT entity schema according to the present disclosure.

FIG. 9 shows a system that can realize the IoT-enhanced search result concepts described herein.

FIG. 10 illustrates an exemplary embodiment of a method according to the present disclosure.

FIGS. 11A, 11B illustrate an exemplary embodiment of a data flow in a system for receiving, processing, and indexing sensor data according to the present disclosure.

FIG. 12 illustrates an exemplary embodiment of an apparatus comprising a processor and memory according to the present disclosure.

### DETAILED DESCRIPTION

Various aspects of the technology described herein are generally directed towards techniques for generating enhanced query formulations by leveraging data from network-coupled devices, e.g., sensors coupled to the Internet of Things (IoT). In an aspect, one or more query-related sensor candidates are retrieved from a sensor entity data store. The most relevant sensor candidates are determined, and the sensor's identities and data are leveraged to alter and enhance the quality and accuracy of query formulations submitted to an online search engine. The techniques may be applied to improve the query understanding capabilities of search engines, as well as natural language processing capabilities of personal digital assistants and other digital information retrieval systems.

The detailed description set forth below in connection with the appended drawings is intended as a description of exemplary means “serving as an example, instance, or illustration,” and should not necessarily be construed as preferred or advantageous over other exemplary aspects. The detailed description includes specific details for the purpose of providing a thorough understanding of the exemplary aspects of the invention. It will be apparent to those skilled in the art that the exemplary aspects of the invention may be practiced without these specific details. In some instances, well-known structures and devices are shown in block diagram form in order to avoid obscuring the novelty of the exemplary aspects presented herein. As used herein, the terms “device” and “sensor” will both be understood to denote network-coupled hardware that is capable of generating signals for processing according to the present disclosure.

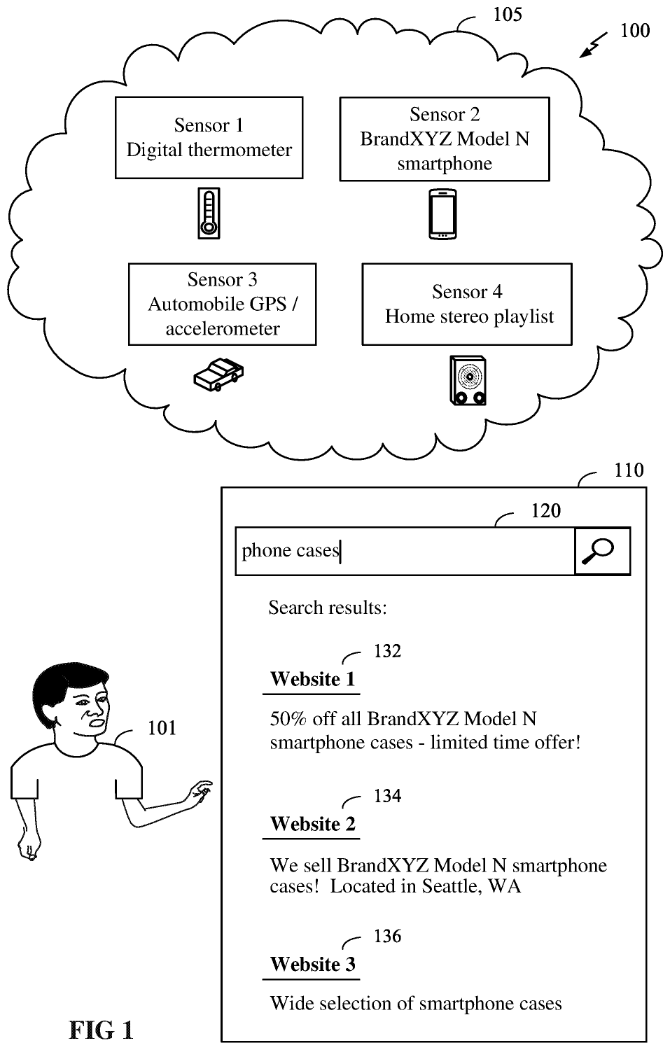

FIG. 1 shows an illustrative application 100 of techniques of the present disclosure. Note FIG. 1 is shown for illustrative purposes only, and is not meant to limit the scope of the present disclosure to any particular sensors, number of signals, devices, queries, search results, or interaction modalities shown. In FIG. 1, exemplary sensors are coupled to an online or “cloud” network 105, also popularly known as the “Internet of Things” (or “IoT”). As IoT-coupled sensors and devices proliferate, new data is continuously generated by interaction of the sensors with users and users' environments.

For example, Sensor 1 is a digital thermometer, which may periodically measure and communicate ambient temperatures at particular times and locales, e.g., a user's home or office. Sensor 2 is a sensor resident on the user's mobile smartphone. Sensor 2 may provide a variety of signals gathered by the smartphone, including GPS location data, gyroscope data regarding device orientation and direction of travel, scheduled user appointments, frequency of use, etc. In certain exemplary embodiments, Sensor 2 may be implemented as a plurality of distinct sensors, each communicating with the IoT via an independent data stream. Sensor 3 is an automobile GPS/accelerometer unit, which may measure and communicate the position and travel speed of the user's automobile. Sensor 4 is a home stereo digital playlist, which may indicate titles, performers, durations, times of playback, etc., of musical selections played on the user's home stereo system, along with other identifying information. In addition to signals measured, each sensor may further communicate identifying and/or functional data about the sensor itself, e.g., its manufacturer, make and model, time elapsed since battery replaced, etc.

Note the above sensors are described for illustrative purposes only, and are not meant to limit the scope of the present disclosure. The present disclosure may readily accommodate other types of sensors and signals not explicitly listed hereinabove, e.g., sensors sensing proximity, infrared, gas and chemicals, motion, etc. These and other sensors and signals are contemplated to be within the scope of the present disclosure.

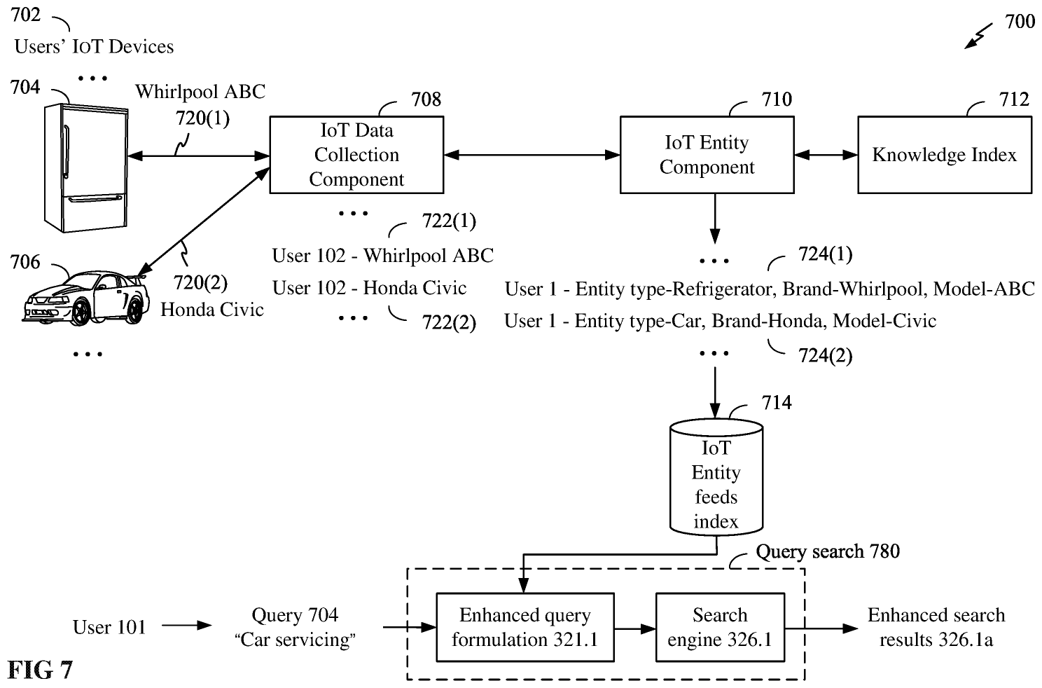

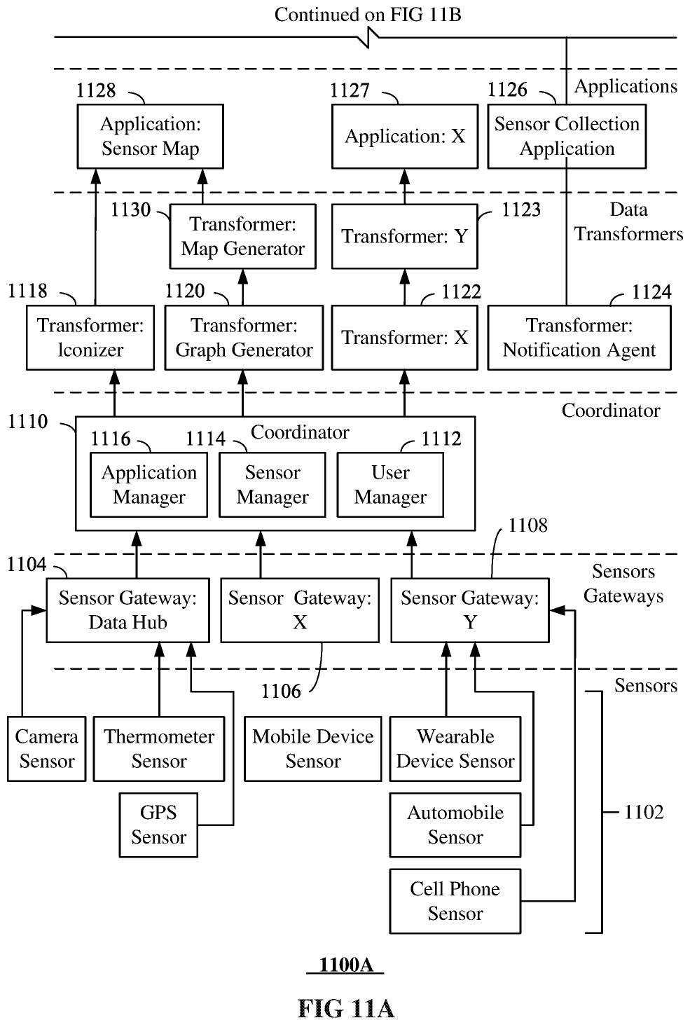

In an exemplary embodiment, certain intermediary entities (not shown in FIG. 1) may be provided in the network to receive and process raw data generated by the sensors, so that they may be suitably used by subsequent modules to provide customized digital services to users. Exemplary embodiments of such intermediary entities are further described hereinbelow, e.g., with reference to FIGS. 7 and 11A, 11B. For example, sensors such as Sensor 1 through Sensor 4 may individually or collectively communicate with one or more network access points, which may in turn connect with one or more networked servers or data repositories, e.g., using independent wireless or wired connections.

It will be appreciated that the various types of data collected by sensors can provide significant context to a user's interaction with his or her personal devices. For example, FIG. 1 illustrates an application wherein, thanks to information gathered from sensors such as Sensor1 through Sensor 4, and further novel processing techniques described hereinbelow, a simple search query 120 for “phone cases” submitted to a search engine interface 110 can retrieve search results 132, 134, 136 specifically customized to the user's particular brand of phone, locale, etc. For example, search result 132 may specifically refer to the user's brand of smartphone, e.g., as derived from data collected by Sensor 2 described hereinabove. Search result 134 may further be customized to the user's physical location, e.g., as derived from Sensor 2 or Sensor 3.

Note the search engine interface 110 may be executed on any of a variety of digital communications devices, e.g., a mobile device such as a smartphone, smart watch, tablet, laptop computer, etc., or other device such as desktop computer, independent or standalone dedicated personal digital assistant device, virtual assistant device, automotive personal assistant, smart appliance, smart speakers, etc. Such devices may generally be configured to provide various other functional services to user 101, such as cellular connectivity and/or Internet access, in addition to the query search functionality described herein.

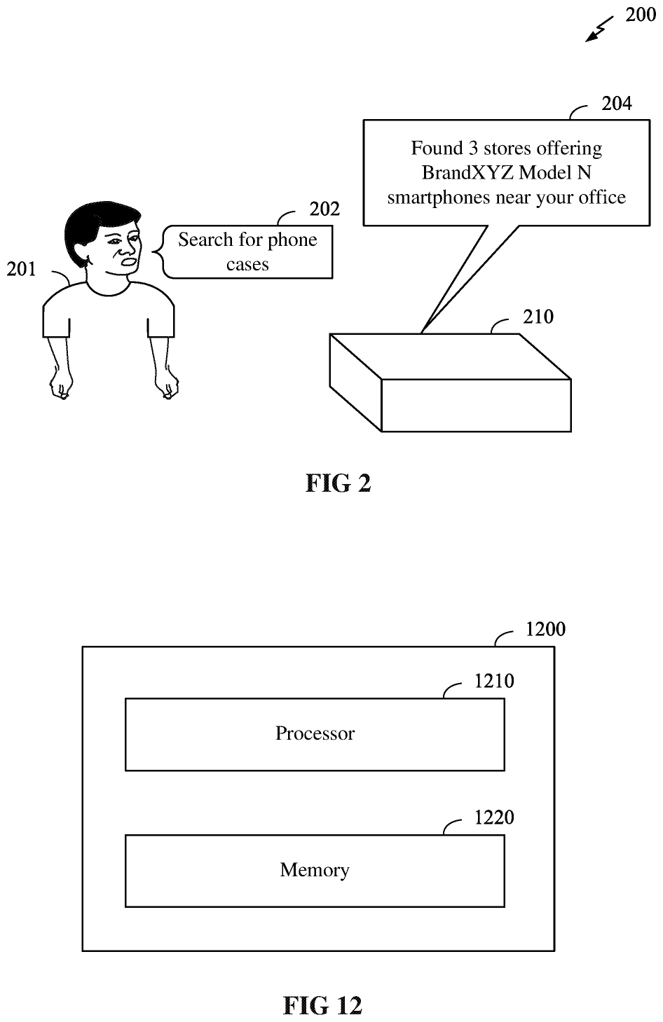

FIG. 2 shows an alternative illustrative application 200 of techniques of the present disclosure. In FIG. 2, user 201 communicates via natural speech with an illustrative hardware device 210. In an exemplary embodiment, device 210 may support a personal digital assistant (PDA) system, e.g., Microsoft Cortana, and may communicate with the user according to any of various user interface modalities, e.g., voice/speech communications using natural language processing, text or graphical entry with visual display, gesture recognition, etc.

In FIG. 2, user 201 illustratively issues a voice query 202 of “search for phone cases” to device 210. In accordance with the enhanced search functionality described herein, device 210 delivers sensor-enhanced search results 204, and may encapsulate the above-mentioned results 132, 134, 136 of FIG. 1 in speech form, e.g., using natural language audio speech synthesis.

In accordance with the above description, the present disclosure discloses various techniques for leveraging sensor data to provide customized digital services to users, thereby affording users a more satisfying interactive experience.

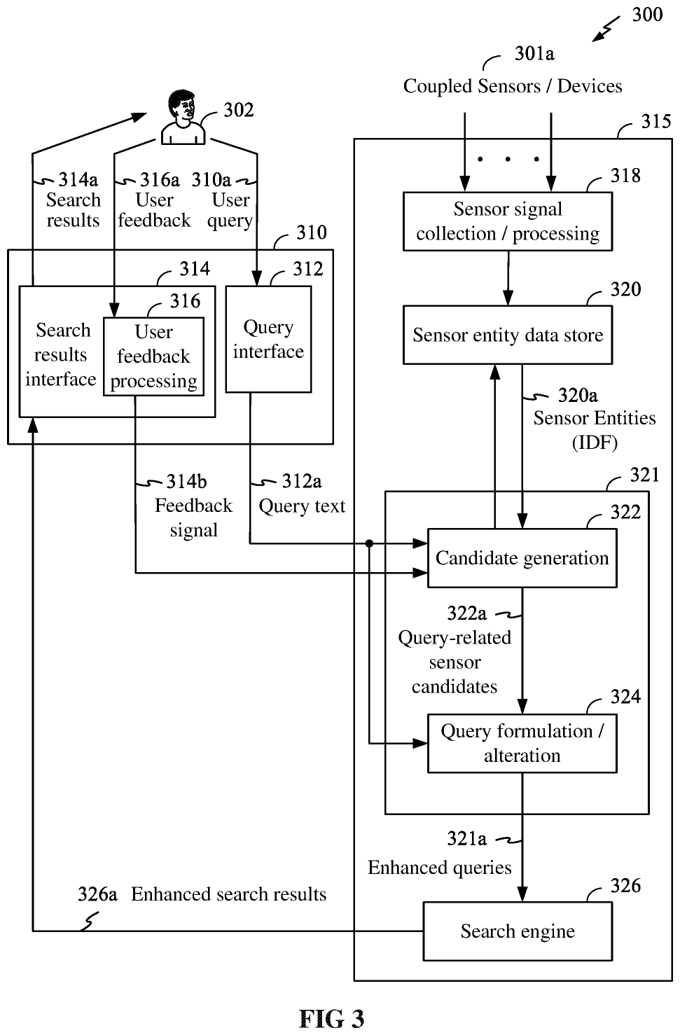

FIG. 3 illustrates an exemplary embodiment 300 of a system for generating sensor-enhanced search results responsive to user queries. Note FIG. 3 is shown for illustrative purposes only, and is not meant to limit the scope of the present disclosure.

In FIG. 3, user 302 submits query 310a to hardware device 310 executing a search engine interface, including query interface 312 and search results interface 314. In particular, query interface 312 extracts query text 312a from user query 310a, and transmits query text 312a to online system 315 for retrieval of relevant search results. Search results interface 314 receives enhanced search results 326a retrieved from system 315 responsive to query 310a, and presents 314a the received search results to the user. In an exemplary embodiment, interfaces 312 and 314 may be implemented by a processor (not shown) of device 310 executing instructions stored in a memory (not shown) of device 310. Note device 310 may generally also support other types of computing functionality independent of query search.

In an exemplary embodiment, device 310 may correspond to a client-side device, e.g., smartphone or computer or other device similar to device 210 described hereinabove with reference to FIG. 2. System 315 may communicate with device 310 through a wired or wireless network connection, e.g., system 315 may include “cloud” servers or devices that perform the requisite functionality at one or more physically remote locations from user 302.

System 315 includes enhanced query formulation module 321, composed of at least two units: candidate generation module 322, and query formulation/alteration module 324. In an exemplary embodiment, candidate generation module 322 and query formulation/alteration module 324 may be implemented on the server side. In alternative exemplary embodiments, any or both of modules 322, 324 may be implemented on the client side.

In an exemplary embodiment, module 322 receives query text 312a from query interface 312 of device 310, and generates query-related sensor candidates 322a from query text 312a. In particular, module 322 may be coupled to sensor entity data store 320, which stores data collected and processed from a multitude of sensors and devices 301a related to user 302, e.g., IoT-coupled sensors and devices 301a. In an exemplary embodiment, sensor entity data store 320 may be coupled to sensor signal collection/processing module 318, which functions to collect and process signals from sensors and devices 301a so that they may be readily accessed by sensor entity data store 320.

In an exemplary embodiment, sensor entity data store 320 may correspond to, e.g., IoT entity feeds index 714, while sensor signal collection/processing module 318 may correspond to, e.g., components 708-710, further described hereinbelow with reference to FIG. 7. In alternative exemplary embodiments, sensor entity data store 320 may correspond to any repository of sensor entities associated with one or more given users, wherein the sensor entities are collected, processed, and extracted in any manner derivable by one of ordinary skill in the art in view of the present disclosure. Such alternative exemplary embodiments are contemplated to be within the scope of the present disclosure.

In an exemplary embodiment, data store 320 may exchange sensor entities data 320a with module 321, and such data 320a may be formatted according to an Indexable Data Format (IDF), as further described with reference to FIGS. 7 and 11A, 11B. In particular, IDF is a data format for facilitating ready retrieval of data about stored sensor entities by other modules such as module 322. Using sensor entities data 320a, module 322 generates a set of sensor candidates 322a that are related to query text 312a for user 302.

The generated sensor candidates 322a are coupled to query formulation/alteration module 324, which combines sensor candidates 322a with the original query text 312a to generate one or more enhanced queries 321a. Enhanced queries 321a are then submitted to online search engine 326 to retrieve enhanced search results 326a. In an exemplary embodiment, online search engine 326 may implement search functionality such as Web crawling, indexing, searching, results ranking, etc. In an exemplary embodiment, engine 326 may be any online search engine, e.g., the Bing search engine, or any component thereof.

Enhanced search results 326a are provided to search results interface 314, which may process and/or format results 326a for presentation to user 302 as search results 314a. For example, interface 314 may perform web page formatting, text-to-speech conversion, etc., so that enhanced search results 326a may be readily communicated to user 302.

In an exemplary embodiment, search results interface 314 may further include user feedback processing module 316 to receive and process user feedback 316a. For example, explicit user selection of a search result 314a incorporating enhanced sensor data or other positive feedback may be fed back to module 322 via feedback signal 314b to strengthen the association between the chosen sensor candidate and the query text. In an exemplary embodiment, the relevance score as described hereinbelow for a given look-up sequence/sensor candidate pair may be increased responsive thereto. Alternatively, user non-selection of a search result 314a or other negative feedback may be fed back to module 322 via feedback signal 314b to weaken the association between the proposed sensor candidate and the query text. In an exemplary embodiment, a corresponding relevance score may be decreased. In certainly exemplary embodiments, positive or negative user feedback may alternatively or further be utilized as an input to dynamically adjust a threshold used for pruning candidates according to a binary classification scheme, as further described hereinbelow.

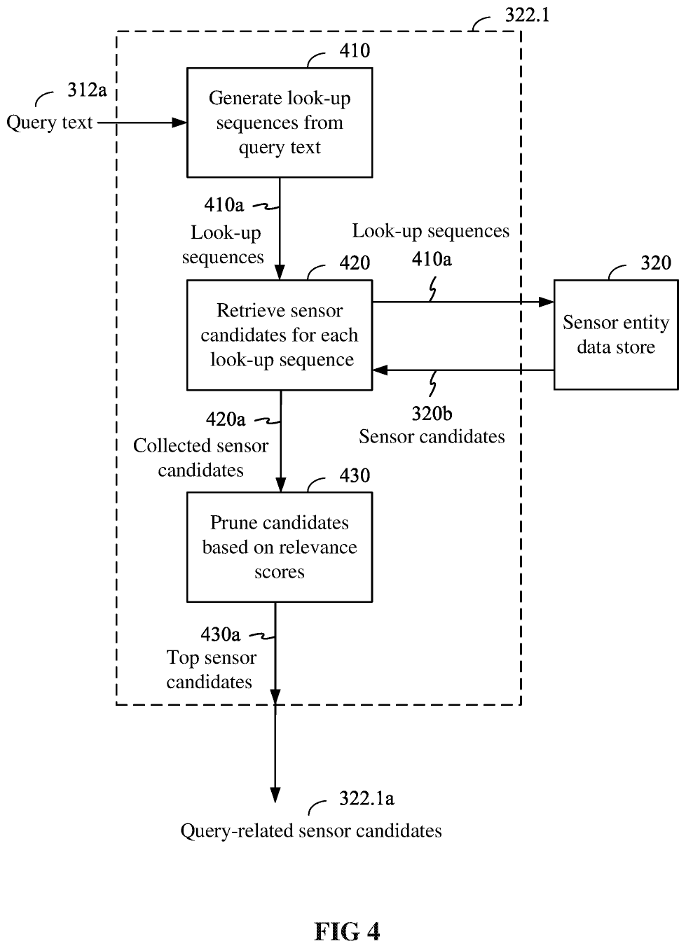

FIG. 4 illustrates operations executed by an exemplary embodiment 322.1 of candidate generation module 322 in FIG. 3. Note FIG. 4 is shown for illustrative purposes only, and is not meant to limit the scope of the present disclosure.

In FIG. 4, query text 312a is received and processed by look-up sequence generation block 410 of module 322. Block 410 generates at least one look-up sequence 410a corresponding to query text 312a. A look-up sequence includes a text sequence derived from query text 312a, wherein such text sequence is specifically designed to facilitate the look-up and retrieval of sensor candidates for query text 312a from sensor entity database 320.

In an exemplary embodiment, a look-up sequence may be generated by splitting query text 312a into individual words or “tokens.” For example, illustrative query text 312a for “phone cases” may be split into two tokens as follows: {“phone,” “cases”}. The resulting tokens are used to generate a set of “n-grams,” wherein each n-gram corresponds to a distinct combination of different tokens. For example, three possible n-grams may be constructed from the above two tokens: {“phone,” “cases,” “phone cases”}. In this exemplary embodiment, three look-up sequences (one for each n-gram) may thus be generated for query text “phones cases.”

Note the above description of generating look-up sequences by text splitting and n-gram construction is given for illustrative purposes only, and is not meant to restrict the scope of the present disclosure. In alternative exemplary embodiments, any operations for modifying query text to obtain more or fewer textual entities may be utilized. For example, word permutations, grammatical modification of words, semantic alteration or augmentation using textual dictionaries or thesauruses, etc., are contemplated to be within the scope of the present disclosure.

Look-up sequences 410a are provided to retrieval block 420, which retrieves sensor candidates 320b from sensor entity data store 320 for each look-up sequence. Each retrieved sensor candidate may identify a sensor or device entity, as well as a variety of attributes of the sensor entity. Each sensor candidate may further be associated with a relevance score, or a numerical quantification of how relevant the sensor candidate is to a given look-up sequence. In an exemplary embodiment, each candidate may further be associated with one or more users.

In an exemplary embodiment, the relevance score may be calculated for each user based on textual similarity between the look-up sequence and a data field (e.g., entity name) of the sensor candidate, cross-correlation metrics, entropy metrics, etc. In an exemplary embodiment, the relevance score may alternatively or further include calculating a weighted mean of numerical representations of the following characteristics of a sensor entity: i) frequency of usage; ii) duration of usage; iii) last used time; iv) novelty factor; and (v) brand of the entity.

In an exemplary embodiment, novelty factor may be a measure of, e.g., how long the user has been using the device. For example, a device which the user has been using for the last four years may be assigned a lower novelty factor than a device which the user acquired last week. In an alternative exemplary embodiment, brand of the entity may be a numerical value quantifying how popular a brand is in a given market, e.g., national or global market. For example, a widely adopted brand may be assigned a higher score than a less widely adopted brand. In an exemplary embodiment, such information may be obtained from knowledge graph or index 712 as further described hereinbelow.

In an exemplary embodiment, attributes for a retrieved sensor candidate may be organized in a predetermined format. For example, one possible format may specify a full identifying name of the entity (e.g., “BrandABC Phone Plus”), a brand name of the manufacturer (e.g., “BrandABC”), a segment type (e.g., “smartphone”), and product type (e.g., “mobile communications”), etc. Note the exemplary data format herein is described for illustrative purposes only, and alternative exemplary embodiments may readily employ other data formats including more or less identifying information about each retrieved entity.

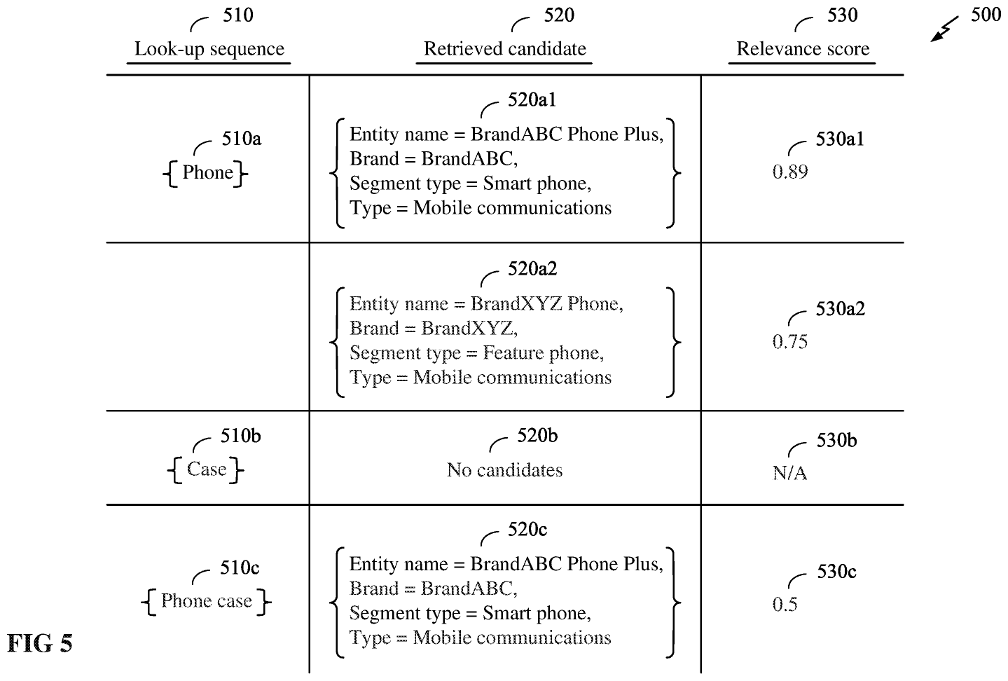

FIG. 5 illustrates exemplary instances of look-up sequences, retrieved candidates, and associated relevance scores. Note FIG. 5 is shown for illustrative purposes only, and is not meant to limit the scope of the present disclosure to any particular instances of text, data formats for retrieved candidates, numerical formats for relevance scores, etc. In FIG. 5, the first column 510 shows exemplary look-up sequences 510a, 510b, 510c, the second column 520 shows sensor candidates retrieved for each look-up sequence, and the third column 530 indicates a relevance score associated with each candidate.

In particular, a first look-up sequence 510a “{phone}” retrieves from the data store two sensor candidates 520a1, 520a2, one corresponding to a smartphone and the other for a feature phone (as defined according to the “segment type” of each candidate). Candidate 520a1 has an illustrative associated relevance score 530a1 of 0.89, while candidate 520a2 has an illustrative associated relevance score 530a2 of 0.75. A second look-up sequence 510b {“case”} is seen to retrieve no candidates 520b and no corresponding relevance score 520b, while a third look-up sequence 510c {“phone case”} is seen to retrieve a single candidate 520c with relevance score 530c of 0.5. Note the exemplary relevance scores are given herein for illustrative purposes only, and is not meant to limit the range or precision of numbers or symbols that may be used to quantify the relevance scores according to the present disclosure.

Returning to FIG. 4, block 420 collects retrieved sensor candidates 320b and provides these as signal 420a to block 430. In an exemplary embodiment, block 430 prunes the collected candidates to preserve the top candidates as ranked by relevance score, while removing the lower-ranking candidates. In exemplary embodiments, the top candidates may be identified as those lying within a predetermined top percentile of the candidates as ranked by relevance score. In alternative exemplary embodiments, the top candidates may be chosen as the top N candidates as ranked by relevance score. In yet alternative exemplary embodiments, a binary classifier may be employed to dynamically select a relevance score threshold, wherein candidates having scores above the threshold are kept, and those below the threshold are pruned. The binary classifier may receive as inputs a candidate, its relevance score, the user, and records of previous user feedback regarding the candidate, e.g., positive or negative feedback responsive to previous query results served in which the candidate entity was utilized as part of the query string. Such alternative exemplary embodiments are contemplated to be within the scope of the present disclosure.

Following pruning, the remaining candidates are output as top sensor candidates 430a. In an exemplary embodiment, top sensor candidates 430a may be provided as query-related sensor candidates 322.1a output by module 322.1.

Referring to module 324 of FIG. 3, based on query-related sensor candidates 322a, query formulation/alteration module 324 may alter or supplement query text 312a with any textual or semantic information presented by candidates 322a. In an exemplary embodiment, module 324 may simply add to query text 312a certain data fields (e.g., entity name or type) from candidates 322a to generate one or more enhanced queries 321a.

In an exemplary embodiment, the entity name of a candidate 322a may be substituted for the corresponding look-up sequence in the query text 312a to generate an enhanced query 321a. For example, based on the illustrative relevance scores in FIG. 5, a look-up sequence {“phone”} may be replaced by its top candidate 520a1 with entity name {“BrandABC Phone Plus”}, and thus query text for “phone cases” may be modified as {“BrandABC Phone Plus cases”}. A further altered query may be generated as {“BrandXYZ Phone cases”}, based on the second highest candidate 520a2.

In an exemplary embodiment, the entity name, type name, or any other field of a candidate may be utilized to augment any query adjustment mechanism for search engines. For example, in certain exemplary embodiments, a speller block may correct query text by identifying commonly misspelled words within the query text, and replacing the misspelled versions with the correct versions. It will be appreciated that the entity names of candidates may readily be utilized to enhance or supplement this function, e.g., by suggesting the correct query text based on the correct entity name or type or other field of the identified candidates. In alternative exemplary embodiments, other functional blocks used for search engine query processing (e.g., query annotation services that utilize classifiers to determine a category type associated with a query, or other services associating entity types to query text) may also be enhanced by the identified candidates, as will be appreciated by one of ordinary skill in the art. Such alternative exemplary embodiments are contemplated to be within the scope of the present disclosure.

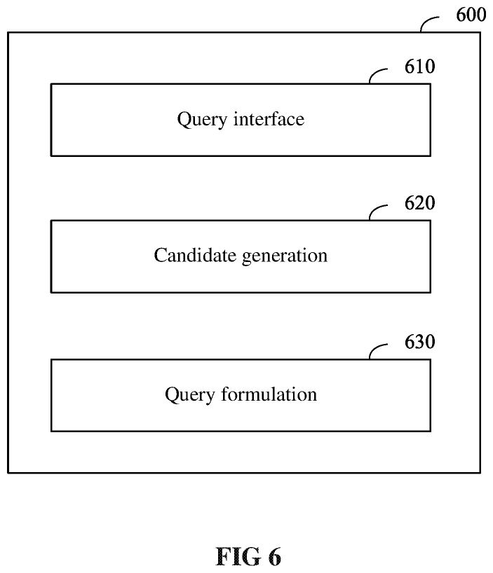

FIG. 6 illustrates an exemplary embodiment of an apparatus 600 according to the present disclosure. Note FIG. 6 is shown for illustrative purposes only, and is not meant to limit the scope of the present disclosure. Apparatus 600 comprises a query interface block 610 configured to receive query text based on a query submitted by a user; a candidate generation block 620 configured to generate at least one look-up sequence corresponding to the query text, and to retrieve, if available, for each of the at least one look-up sequence at least one sensor candidate from a digital sensor entity data store, each of the retrieved at least one sensor candidate associated with a relevance score quantifying relevance between the look-up sequence and the sensor candidate, and to preserve one or more of the retrieved sensor candidates based on the corresponding relevance scores to generate query-related sensor candidates; and a query formulation block 630 configured to alter the query text based on the query-related sensor candidates to submit the altered query text to an online search engine to retrieve results relevant to the submitted query.

FIG. 7 illustrates an exemplary embodiment 700 of an IoT data collection system in which techniques of the present disclosure may be applied. Note FIG. 7 is shown for illustrative purposes only, and is not meant to limit the scope of the present application to any particular implementation of IoT sensor data collection or processing shown.

In FIG. 7, an IoT enhanced search system 700 can include and/or communicate with various users' IoT devices 702. In the illustrated example, the users' IoT devices 702 include a refrigerator 704 and a car 706 that are associated with user 102. For sake of brevity, only two IoT devices relating to one user are illustrated for purposes of explanation. Further, this example shows a one-to-one relationship between items and IoT devices (e.g., a car includes a single IoT device). However, a single item could include multiple IoT devices. For instance, a car could have an IoT device for its electrical system, an IoT device for its emission system, an IoT device for its fuel system, etc. Thus, a real-world implementation may include billions of IoT devices associated with millions of users and system 700 is configured to handle such an implementation.

System 700 can include and/or communicate with an IoT data collection component 708, an IoT entity component 710, a knowledge graph or index 712, an IoT entity feeds index 714, a search index 716, and/or an IoT enhanced ranker 718. In this example, the search index 716 and the IoT enhanced ranker 718 can be provided by a search engine 719, but other configurations are contemplated.

IoT data collection component 708 can be viewed as a central hub where sensor data from users' IoT devices 702 is communicated at 720. For instance, in this example, the IoT data 720 includes “Whirlpool ABC” at 720(1). (Note “ABC” is a contrived model of refrigerator). The IoT data 720 also includes “Honda Civic” at 720(2). For sake of brevity the amount of IoT device data in the illustrated example is relatively brief. However, more extensive IoT device could be conveyed. For instance, relative to the Honda, the IoT device data could include mileage, status of various systems, percent of oil life remaining, next projected service, etc. The IoT data collection component can associate the IoT data with a particular user. In this case, at 722(1) the “Whirlpool ABC” is associated with user 101. “Honda Civic” is associated with user 101 at 722(2).

In some cases, a client component (not specifically illustrated) can run on the IoT devices 702 and can collect information from the IoT device. The client component can send the information to the IoT data collection component 708. In some of these configurations, the client component can include a push-based notification agent. The push-based notification agent can detect changes in the state of the IoT device and push the updated state to the IoT data collection component 708. The type of information about the IoT device and/or change frequencies can vary based upon device type and/or environment. For instance, a car parked in a garage may send less data and/or send the data less frequently than a car driving down the road.

At this point, the system 700 includes IoT device data 722. However, this IoT device data may not be in a form that is recognized and/or useful in a search context. Stated another way, the IoT device data 722 may not be optimal in a search context. IoT entity component 710 can extract and process the data from IoT data collection component 708. The extraction and processing can entail multiple stages. For instance, one stage can process and ingest the IoT device data 722 in an intermediate store. Another stage can include integration of all IoT device data 722 across different IoT applications to draw correlations. Another stage can entail periodically reading IoT device data 722 from the intermediate store and store it in distributed storage. Another stage can entail deserializing the IoT device data 722 and converting the IoT data into an indexable data format (IDF).

In some implementations, the IoT entity component 710 can analyze the IoT device data 722 relative to entity and popularity indexes. Stated another way, this analysis can identify entities in the IoT device data 722. For instance, the IoT entity component 710 can extract entity names from the IoT device data 722 by finding matches between the IoT device data and the entity indexes. The IoT entity component 710 can also employ a popularity index relative to the IoT device data. For example, the popularity index can be populated with various entity information relating to frequency of usage, duration of usage, last time use, novelty factor, and/or brand of entity, among others. For instance, one manifestation of the population graph can include a weighted mean of these facets. Thus, once the IoT entity component identifies an entity in the IoT device data, the IoT entity component can identify how often that entity is accessed (e.g., what entities does the IoT device data relate to and how interested is the user in individual entities).

IoT entity component 710 can utilize knowledge index 712 to derive additional information about the IoT device data 722. For instance, IoT entities from the IoT device data can be compared to the knowledge index 712. Various knowledge indexes can be employed. Search engine knowledge indexes are readily available. The process can compare entities of the IoT device data to entities of the knowledge index. If an entity match is found, the existing entity ID and metadata from the knowledge index can be utilized by the IoT entity component 710. In an alternative case where the entity is not found, the new IoT entity from the IoT device data can added to the knowledge index for future use.

IoT entity component 710 can also identify related entities (such as parent and/or child relationships (e.g., ontological relationships)) and metadata associated with the IoT entity using N step graph traversal over the knowledge graph 712. Thus, in the illustrated example, the IoT entity component 710 obtains additional information relative to the IoT device data 722. This additional information is reflected at 724 and can be viewed as structured IoT device data (e.g., the IoT device data is augmented with information about the IoT device data).

The structured IoT device data 724 can be compared to the IoT device data 722 for purposes of explanation. As indicated at 724(1) the additional information specifies that “Whirlpool” is an entity of entity type “refrigerator,” and “ABC” is a model of Whirlpool refrigerator. Similarly, as indicated at 724(2) the additional information specifies that “Honda” is an entity of entity type “car,” and “Civic” is a model of Honda car. Some of this information was in the IoT device data. For instance, “Honda” was in the IoT device data, but without context. The knowledge graph provided information that Honda is an entity. Other information was not in the IoT device data 722 and was derived from the knowledge graph. For instance, the information that the entity Honda has a child relationship to parent entity type of car was derived from the knowledge graph and added to the structured IoT device data 724(2). Thus, from one perspective, the structured IoT device data 724 can add context to the IoT device data 722 that makes the structured IoT device data useful or meaningful in the search context.

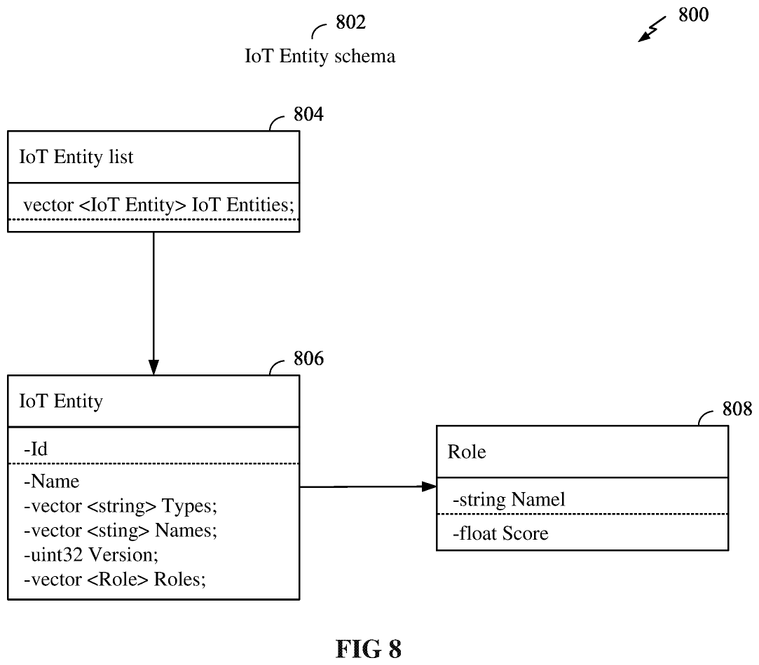

The structured IoT device data 724 can be added to the IoT entity feeds index 714. For instance, in some implementations, the identified entities can be ingested into the IoT entity feeds index 714 with several fields, such as user ID, entity ID, popularity index, etc. In this case, a user ID can be an anonymous unique identifier for the user in the system 700. The entity ID can be the search engine knowledge base unique ID. The popularity index can be a score of relevance which is a measure of trending interest (e.g., relative trending popularity), virality, and/or usefulness. In some implementations, the structured IoT device data 724 can be converted into an indexable data format (IDF) for the IoT entity feeds index 714. FIG. 8 shows an IoT entity schema for this conversion.

In an exemplary embodiment, IoT entity feeds index 714 may correspond to sensor entity data store 320 of FIG. 3. In alternative exemplary embodiments, sensor entity data store 320 of FIG. 3 need not be implemented as shown for IoT entity feeds index 714 in FIG. 7, and such alternative exemplary embodiments are contemplated to be within the scope of the present disclosure.

In this example, the user 101 submits the query 704 for “car servicing” as introduced in the scenarios above in FIG. 1. This query 704 can be submitted to query search module 780, which includes enhanced query formulation module 321.1 and search engine 326.1. In an exemplary embodiment, module 321.1 may be implemented according to the techniques described hereinabove for module 321 of FIG. 3. In particular, module 321.1 may include a module 322 for generating query-related sensor candidates, and a query formulation/alteration module 324 for formulating enhanced queries 321a. In an exemplary embodiment, module 322 of module 321.1 may be coupled to IoT entity feeds index 714 as sensor entity data store 320. The output 321.1a of module 321.1 may correspond to enhanced queries 321a, as earlier described hereinabove with reference to FIG. 3. In an exemplary embodiment, enhanced queries 321a are provided to search engine 326.1, which may perform similar functionality as described hereinabove with reference to search engine 326 of FIG. 3.

FIG. 8 shows an exemplary IoT entity schema 802 mentioned above relative to the discussion of FIG. 7. The IoT entity schema can provide a technique for converting structured IoT device data (724, FIG. 7) into indexable data format for the IoT entity feeds index 714. The indexable data format can relate to entities in an IoT entity list 804, to properties or attributes of the entities at 806, and/or roles of the entities at 808.

In one case, the IoT entity schema 802 can be employed in an index build environment for the IoT entity feeds index (714, FIG. 7). In the index build environment, the generated indexable data format can be processed into the index and content chunks that can be consumed by the IoT entity feeds index. An index as a service environment can download (e.g., stream) the chunk files generated by the index build as they are available. Periodically, the IoT entity feeds index can begin a merge process. During index merge, the index chunk files can be combined into a new, complete version of the IoT entity feeds index.

Indexing of IoT entities can be accomplished in a search index (e.g., IoT entity feeds index) for fast search and retrieval. A popularity score can be generated for each entity using weighted mean of temporal dimensions. A rules-based re-ranking level can be enhanced with IoT entities and their popularity score to improve search results. User selections from the enhanced or improved search results can be used in a feedback loop to improve search engine engagement. The systems can be employed by a party working directly with the user. For instance, a party associated with a search engine could employ the systems to provide better search results. Alternatively, the system can be employed indirectly for a first party working directly for the user. For instance, the system can be employed by a second party and surfaced as an application program interface (API) that is made available to the first party. For example, the first party may be an application developer that is providing an application that the user has on his/her smart phone. The application may receive a search query from the user. The first party can run the search query through the API and get the IoT enhanced query results without any knowledge of the processes being performed under the guidance of the second party.

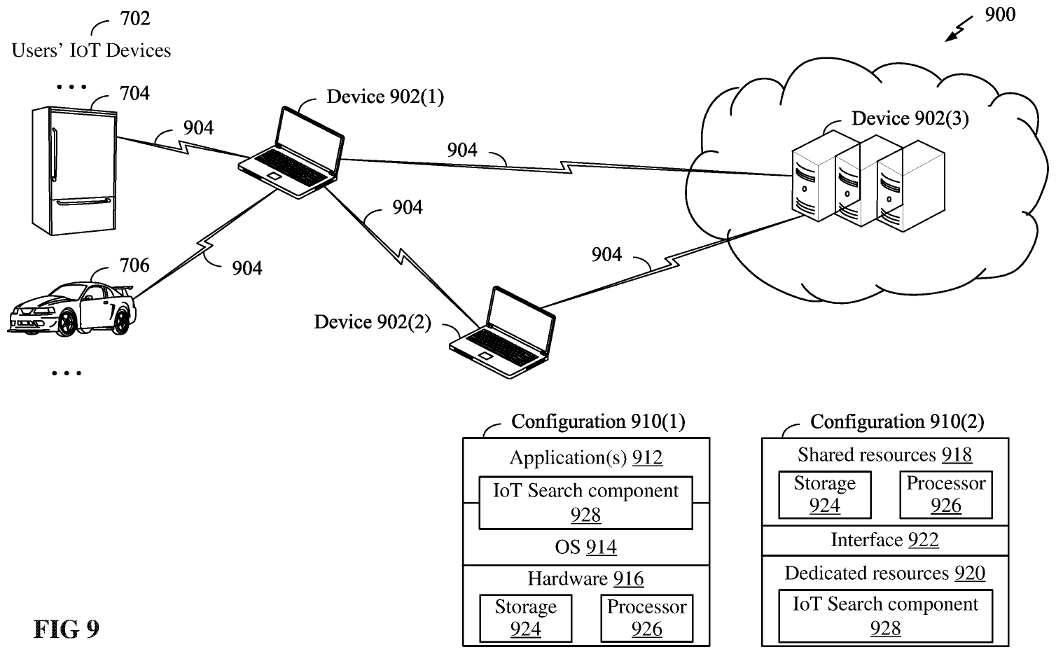

FIG. 9 shows a system 900 that can realize the IoT-enhanced search concepts described herein. For purposes of explanation, system 900 includes users IoT device 702 including refrigerator 704 and car 706. System 900 can also include one or more devices 902. In the illustrated example, devices 902(1) and 902(2) are manifest as notebook computer devices and example device 902(3) is manifest as a server device. Sensors 1 through 4 of FIG. 1 can also be viewed as example devices 902. The users' IoT devices 702 and devices 902 can communicate via one or more networks (represented by lightning bolts 904) and/or can access the Internet over the networks. In some cases, parentheticals are utilized after a reference number to distinguish like elements. Use of the reference number without the associated parenthetical is generic to the element. Devices 902 can be proximate to one another and/or distributed. Further, the device 902 can be proximate to and/or remote from users' IoT device 702.

FIG. 9 shows two device configurations 910 that can be employed by devices 902. Individual devices 902 can employ either of configurations 910(1) or 910(2), or an alternate configuration. (Due to space constraints on the drawing page, one instance of each configuration is illustrated rather than illustrating the device configurations relative to each device 902). Briefly, device configuration 910(1) represents an operating system (OS) centric configuration. Configuration 910(2) represents a system on a chip (SOC) configuration. Configuration 910(1) is organized into one or more applications 912, operating system 914, and hardware 916. Configuration 910(2) is organized into shared resources 918, dedicated resources 920, and an interface 922 therebetween.

In either configuration 910, the device can include storage/memory 924, a processor 926, and/or an IoT search component 928. The IoT search component 928 can include any or all of the IoT data collection component 708, IoT entity component 710, knowledge index 712, IoT entity feeds index 714, and/or query search module 780 introduced above in relation to FIG. 7. The IoT search component 928 can be configured to receive search results for a search query entered by an individual user and to obtain the IoT entities from the IoT device data associated with the individual user. The IoT search component 928 can further be configured to enhance the original search query using IoT entity data prior to submission to a search engine, as described hereinabove. The IoT search component 928 can be configured to rank the search results utilizing the IoT entities from the IoT device data associated with the individual user. The IoT search component 928 can provide the user with the ranked search results that are more relevant to the individual user than would be obtained without the entities from the IoT device data.

In some configurations, each of devices 902 can have an instance of the IoT search component 928. However, the functionalities that can be performed by IoT search component 928 may be the same or they may be different from one another. For instance, in some cases, each device's IoT search component 928 can be robust and provide all of the functionality described above and below (e.g., a device-centric implementation). In other cases, some devices can employ a less robust instance of the IoT search component 928 that relies on some functionality to be performed remotely. For instance, device 902(3) may have more processing resources than device 902(1). As such, some of the functionality can be performed locally on device 902(1) and other functionality can be outsourced to device 902(3). Device 902(3) can return the results of its processing to device 902(1).

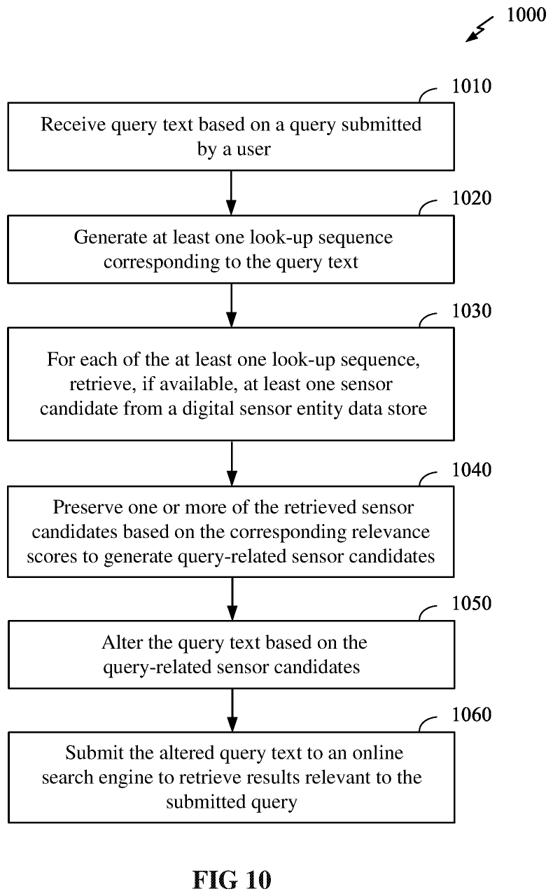

FIG. 10 illustrates an exemplary embodiment of a method 1000 according to the present disclosure. Note FIG. 10 is shown for illustrative purposes only, and is not meant to limit the scope of the present disclosure.

In FIG. 10, at block 1010, query text is received based on a query submitted by a user. At block 1020, at least one look-up sequence is generated corresponding to the query text. At block 1030, for each of the at least one look-up sequence, at least one sensor candidate, if available, is retrieved from a digital sensor entity data store, each of the retrieved at least one sensor candidate associated with a relevance score quantifying relevance between the look-up sequence and the sensor candidate. At block 1040, one or more of the retrieved sensor candidates is preserved based on the corresponding relevance scores to generate query-related sensor candidates. At block 1050, the query text is altered based on the query-related sensor candidates. At block 1060, the altered query text is submitted to an online search engine to retrieve results relevant to the submitted query.

FIGS. 11A, 11B illustrate an exemplary embodiment of a data flow in a system for receiving, processing, and indexing sensor data according to the present disclosure. Note FIGS. 11A, 11B are shown for illustrative purposes only, and are not meant to limit the scope of the present disclosure to any particular data flows for receiving, processing, and indexing sensor data shown.

In FIG. 11A, the system 1100 can include any number of sensors 1102 such as a camera, a thermometer, an accelerometer, a mobile device sensor, a pedometer, an automobile based sensor, a robot based sensor, and the like. In some examples, the sensors 1102 can transmit sensor data to sensor gateways 1104, 1106, and 1108. The sensor gateways 1104, 1106, and 1108 can provide a uniform interface between the sensors 1102 and a coordinator 1110. For example, the sensor gateways 1104, 1106, and 1108 can normalize sensor data detected from sensors built using many different platforms widely varying in processing power, energy, and bandwidth capabilities. In some examples, the sensors 1102 can have different access interfaces such as radios to communicate with low powered wireless sensor nodes or serial buses for high-speed communications and isochronous data transfer with higher power and higher bandwidth sensors. In some examples, the sensors 1102 may not be connected at all times to the sensor gateways 1104, 1106, and 1108. The sensor gateways 1104, 1106, and 1108 can implement sensor specific techniques to communicate with each sensor 1102.

In some embodiments, the coordinator 1110 can access the sensor gateways 1104, 1106, and 1108 to obtain sensor data streams, to submit data collection demands, or access sensor characteristics through a standardized web service application programming interface (API). In some examples, each sensor 1102 may maintain a separate sensor gateway 1106. In some embodiments, the sensor gateways 1104, 1106, and 1108 can implement sharing policies defined by a contributor. For example, the sensor gateways 1104, 1106, and 1108 can maintain raw data in a local database for local applications executed by a sensor 1102, which can maintain private data while transmitting non-private data to the coordinator 1110. In some embodiments, a datahub sensor gateway 1104 can be used by sensors 1102 that do not maintain their own sensor gateway. In some examples, individual sensors can publish their data to a datahub sensor gateway 1104 through a web service API.

In some embodiments, the coordinator 1110 can be a point of access into the system 1100 for applications and sensors 1102. The coordinator 1110 can include a user manager 1112, a sensor manager 1114, and an application manager 1116. The user manager 1112 can implement user authentication mechanisms. In some embodiments, the sensor manager 1114 can provide an index of available sensors 1102 and the characteristics of the sensors 1102. For example, the sensor manager 1114 can convert user friendly sensor descriptions, such as location boundaries, logical names, or sensor types, to physical sensor identifiers. The sensor manager 1114 can also include APIs for sensor gateways 1104, 1106, and 1108 to manipulate sensors 1102 and the type of sensors 1102. For example, the sensor manager 1114 can define new sensor types, register new sensors of defined types, modify characteristics of registered sensors, and delete registered sensors.

In some embodiments, the application manager 1116 can be an access point to shared data for additional components in the system 1100. In some examples, the application manager 1116 can manage the sensor gateways 1104, 1106, and 1108. The application manager 1116 can also accept sensing queries from additional components and satisfy the sensing queries based on available sensors 1102. In some embodiments, to minimize a load on the sensors 1102 or the respective sensor gateways 1104, 1106, and 1108, the application manager 1116 can attempt to combine the requests for common data. The application manager 1116 can also cache recently accessed sensor data so that future queries without stringent real-time requirements can be served by local caches.

In some embodiments, the coordinator 1110 can transmit data to data transformers 1118, 1120, 1122, 1123, and 1124. The data transformers 1118, 1120, 1122, 1123, and 1124 can convert data semantics through processing. For example, a data transformer 1118-1124 can extract the people count from a video stream, perform unit conversion, perform data fusion, and implement data visualization services. In some examples, transformers 1118-1124 can perform different tasks. For example, an iconizer data transformer 1118 can convert raw sensor readings into an icon that represents a sensor type in the icon's shape and sensor value in the icon's color. In some examples, graphical applications can use the output of the iconizer data transformer 1118 instead of raw sensor values. In another example, a graph generator data transformer 1120 can obtain raw sensor readings and generate 2D spatial graphs. In some embodiments, a notification agent 1124 can determine when to transmit sensor data to a sensor collection application 1126.

In some examples, applications utilize sensor data for executing instructions. The applications 1126, 1127, and 1128 can be interactive applications where users specify data needs such as user queries for average hiker heart rate over the last season on a particular trail, among others. The applications 1126, 1127, and 1128 can also include automated applications in backend enterprise systems that access sensor streams for business processing, such as an inventory management application that accesses shopper volume from parking counters, customer behaviors from video streams, and correlates them with sales records. In one example, a sensor map application 1128 can visualize sensor data from the iconizer transformer 1118 and a map generator transformer 1130 on top of a map representation of a location.

In some embodiments, the sensor collection application 1126 can collect sensor data from any number of the sensors 1102 and transmit the sensor data to an intermediate store 1132. In some examples, the sensor collection application 1126 can implement a policy to collect sensor data that deviates from a previous value by more than a predetermined threshold. For example, the sensor collection application 1126 may store sensor data from a thermometer sensor if a value is at least a certain number of degrees above or below a previously detected value. If the sensor collection application 1126 detects sensor data below a predetermined threshold, the sensor collection application 1126 can discard or delete the sensor data. Accordingly, the sensor collection application 1126 can limit a size of sensor data collected from each sensor 1102 and transmitted for storage in the intermediate store 1132 of FIG. 11B.

In some embodiments, the predetermined threshold can be different for each sensor 1102. For example, the predetermined threshold can indicate that a number of steps from a pedometer that exceeds a previously detected value are to be stored in the intermediate store 1132. In another example, the predetermined threshold can indicate that location data from a global positioning system sensor is to be stored if a new location is more than a predetermined distance from a previously detected value. In yet another example, the predetermined threshold can indicate that a number of users detected in a video frame or image is to be stored if an increase or decrease from a previously detected value exceeds a threshold value. Accordingly, the intermediate store 1132 can store the sensor data that exceeds the predetermined threshold detected from any suitable number of sensors. The smaller sensor data set stored in the intermediate store 1132 can enable faster analysis and limit storage requirements for the system 1100. In some examples, the smaller sensor data set can enable the intermediate store 1132 to store data from a larger number of sensors 1102.

In some examples, a process job 1134 can retrieve the sensor data stored in the intermediate store 1132 as part of offline store processing 1136. The process job 1134 can transmit the retrieved sensor data to an aggregator module 1138 that can aggregate sensor data based on time information. For example, sensor data from sensors 1102 stored in the intermediate store 1132 can be aggregated based on a common time frame during which the sensor data was collected. In some embodiments, the aggregator module 1138 can aggregate sensor data based on any suitable fixed or variable period of time. For example, sensor data from sensors 1102 can be aggregated within larger time periods during particular hours of a day or during particular days of a week. In some examples, the aggregator module 1138 can aggregate sensor data with smaller time periods during daytime hours when a larger amount of sensor data is collected and aggregate sensor data with larger time periods during nighttime hours when a smaller amount of sensor data is collected.

In some embodiments, the aggregator module 1138 can transmit the aggregated sensor data to a post processor 1140. In some examples, the post processor 1140 can transform the sensor data aggregated based on time periods into an indexable data format (IDF) 1142. The IDF data can enable search of and access to the aggregated search data in a shorter period of time.

In some embodiments, the IDF data 1142 can be transmitted to an index serve 1144 that includes a feeds index 1146. The feeds index 1146 can include a lookup table, wherein data is stored in a <key, value> format. In some examples, the feeds index 1146 can create multiple lookup <key, value> pairs based on sensor data. In some embodiments, the index serve 1144 can retrieve a generated IDF data file 1142 and process the IDF data file 1142 into content chunks that are incorporated into a feeds index 1146. In some examples, an index as a service (laaS) environment can retrieve or stream the content chunks generated by the feeds index 1146 as the content chunks become available. In some examples, the index serve 1144 periodically initiates a merge process. During an index merge on the feeds index 1146, the index chunk files are combined into a new complete version of the index.

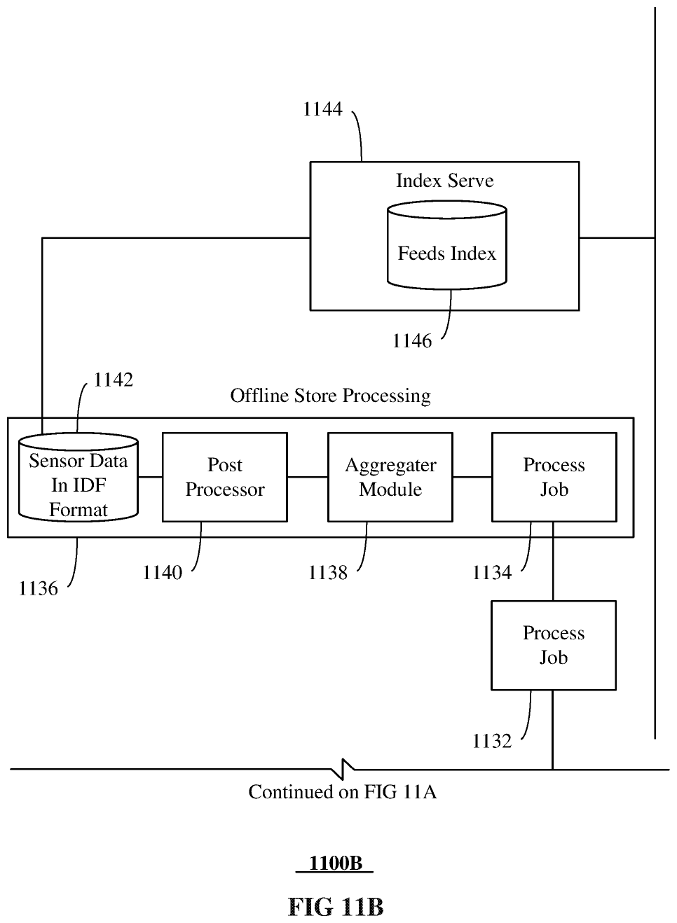

FIG. 12 illustrates an exemplary embodiment of an apparatus 1200 comprising a processor 1210 and a memory 1220 according to the present disclosure. In an exemplary embodiment, memory 1220 stores instructions executable by the processor 1210 to cause the processor to: receive query text based on a query submitted by a user; generate at least one look-up sequence corresponding to the query text; for each of the at least one look-up sequence, retrieve, if available, at least one sensor candidate from a digital sensor entity data store, each of the retrieved at least one sensor candidate associated with a relevance score quantifying relevance between the look-up sequence and the sensor candidate; preserve one or more of the retrieved sensor candidates based on the corresponding relevance scores to generate query-related sensor candidates; alter the query text based on the query-related sensor candidates; and submit the altered query text to an online search engine to retrieve results relevant to the submitted query.

In this specification and in the claims, it will be understood that when an element is referred to as being “connected to” or “coupled to” another element, it can be directly connected or coupled to the other element or intervening elements may be present. In contrast, when an element is referred to as being “directly connected to” or “directly coupled to” another element, there are no intervening elements present. Furthermore, when an element is referred to as being “electrically coupled” to another element, it denotes that a path of low resistance is present between such elements, while when an element is referred to as being simply “coupled” to another element, there may or may not be a path of low resistance between such elements.

The functionality described herein can be performed, at least in part, by one or more hardware and/or software logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

While the invention is susceptible to various modifications and alternative constructions, certain illustrated implementations thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

1. A method comprising:
receiving query text based on a query submitted by a user;
generating at least one look-up sequence corresponding to the query text;
for each of the at least one look-up sequence, retrieving, if available, at least one sensor candidate from a digital sensor entity data store, each of the retrieved at least one sensor candidate associated with a relevance score quantifying relevance between the look-up sequence and the sensor candidate;
preserving one or more of the retrieved sensor candidates based on the corresponding relevance scores to generate query-related sensor candidates;
altering the query text based on the query-related sensor candidates; and
submitting the altered query text to an online search engine to retrieve results relevant to the submitted query.

2. The method of claim 1, the submitted query comprising text submitted through a textual interface of a mobile device.

3. The method of claim 1, the submitted query comprising a voice query submitted to a natural language processing unit of a mobile device.

4. The method of claim 1, the generating the at least one look-up sequence comprising:
extracting one or more tokens from the query text; and
constructing one or more n-grams based on combinations of the one or more tokens.

5. The method of claim 1, each of the at least one sensor candidate comprising an entity name associated with a sensor coupled to a network.

6. The method of claim 5, each of the at least one sensor candidate further comprising at least one of a brand name, segment type, and product type associated with a sensor.

7. The method of claim 1, further comprising calculating the relevance score based on textual similarity between the look-up sequence and a data field of the sensor candidate.

8. The method of claim 1, further comprising calculating the relevance score based on a weighted mean of sensor characteristics comprising: frequency of usage, duration of usage, last-used time, and novelty factor.

9. The method of claim 1, the altering the query text comprising:
replacing one or more words in the query text with an entity name of a sensor candidate retrieved for a look-up sequence corresponding to the one or more words.

10. The method of claim 1, the altering the query text comprising:
providing the query-related sensor candidates to a speller module of a search engine interface to correct spelling in the query text.

11. An apparatus comprising:
a query interface block configured to receive query text based on a query submitted by a user;
a candidate generation block configured to generate at least one look-up sequence corresponding to the query text, and to retrieve, if available, for each of the at least one look-up sequence at least one sensor candidate from a digital sensor entity data store, each of the retrieved at least one sensor candidate associated with a relevance score quantifying relevance between the look-up sequence and the sensor candidate, and to preserve one or more of the retrieved sensor candidates based on the corresponding relevance scores to generate query-related sensor candidates;
and a query formulation block configured to alter the query text based on the query-related sensor candidates to submit the altered query text to an online search engine to retrieve results relevant to the submitted query.

12. The apparatus of claim 11, the submitted query comprising text submitted through a textual interface of a mobile device.

13. The apparatus of claim 11, the submitted query comprising a voice query submitted to a natural language processing unit of a mobile device.

14. The apparatus of claim 11, the candidate generation block configured to generate the at least one look-up sequence by:
extracting one or more tokens from the query text; and
constructing one or more n-grams based on combinations of the one or more tokens.

16. The apparatus of claim 11, each of the at least one sensor candidate comprising an entity name associated with a sensor coupled to a network.

16. The apparatus of claim 15, each of the at least one sensor candidate further comprising at least one of a brand name, segment type, and product type associated with a sensor.

17. The apparatus of claim 11, the relevance score calculated based on textual similarity between the look-up sequence and a data field of the sensor candidate.

18. The apparatus of claim 1, the relevance score calculated based on a weighted mean of sensor characteristics comprising: frequency of usage, duration of usage, last-used time, and novelty factor.

19. An apparatus comprising a processor and a memory storing instructions executable by the processor to cause the processor to:
receive query text based on a query submitted by a user;
generate at least one look-up sequence corresponding to the query text;
for each of the at least one look-up sequence, retrieve, if available, at least one sensor candidate from a digital sensor entity data store, each of the retrieved at least one sensor candidate associated with a relevance score quantifying relevance between the look-up sequence and the sensor candidate;
preserve one or more of the retrieved sensor candidates based on the corresponding relevance scores to generate query-related sensor candidates;
alter the query text based on the query-related sensor candidates; and
submit the altered query text to an online search engine to retrieve results relevant to the submitted query.

20. The apparatus of claim 19, the submitted query comprising text submitted through a textual interface of a mobile device.
